(19) United States
(12) Patent Application Publication
(10) Pub. No.: US 2012/0198766 A1
(43) Pub. Date: Aug. 9, 2012

(54) METHOD FOR ADAPTIVE REUSE OF HISTORIC BUILDINGS FOR HIGH DENSITY ORGANIC AGRICULTURE

(76) Inventor: Bruce J. DeBolt, Vista, CA (US)

(21) Appl. No.: 13/365,044

(22) Filed: Feb. 2, 2012

Related U.S. Application Data
(60) Provisional application No. 61/439,286, filed on Feb. 3, 2011.

(51) Int. Cl. A01G 9/02

(52) U.S. Cl. 47/66.7

(57) ABSTRACT

A method for adaptive reuse of historic buildings for high density organic agriculture reutilizes historic properties with opaque walls. The method creates environmentally controlled plant growing chambers within a retrofitted historic structure that reduces logistics costs and negative environmental impacts while improving the quality of herbs, fruits, vegetables, and other organic products. The method grows products closer to consumers and with a year round production capability. The present invention collects light for plants, delivers water and nutrients to plants, monitors and adjusts the temperature and humidity of the growing chamber, allows for harvesting of the plants, and recycles materials. The method promotes plant growth in a historic structure that may otherwise not support agriculture within a darkened old building.

### CROSS-REFERENCE TO RELATED APPLICATION

This non-provisional application claims priority to the pending provisional application 61/439,286 filed on Feb. 3, 2011 which is owned by the same inventor.

### BACKGROUND OF THE INVENTION

The method for adaptive reuse of historic buildings for high density organic agriculture generally relates to artificial growing methods and more specifically to growing plants within multiple story buildings. More particularly, the invention relates to supplying the inputs needed by plants, including lighting, within old urban buildings to produce a desired agricultural product.

As America underwent the industrial revolution, various factories, warehouse, and other structures appeared. The structures served the people who worked in them and the cities around them. For many decades those is structures made various consumer products, stored materials, and served as headquarters for service providers. However, following World War II, commerce, especially manufacturing, began to leave the city cores across the country.

To retain people in the city cores and to stimulate re-use of structures, various states and municipalities established historic districts and tax credits for re-use of existing structures. Though initially for manufacturing, warehousing, and the like historic structures may now serve a variety of uses. The uses include residential lofts, light offices, high tech manufacturing, and the like as desired by a city and needed by commerce.

### DESCRIPTION OF THE PRIOR ART

Over the years, farmers and growers have built and used various agricultural structures on large land holdings. Farmers utilize barns for grain storage and livestock housing. Growers use greenhouses for growing plants from seed or cutting to seedling. Greenhouses usually have a single story and transparent surfaces to maximize collection of sunlight within a greenhouse. Greenhouses usually have a frame with transparent panels between frame members or a transparent sheet placed upon the frame. A greenhouse of multiple stories is a rare sight in deed.

The present invention overcomes the disadvantages of the prior art and provides a method for adaptive reuse of historic buildings for high density organic agriculture that uses existing structures of any height and collects sufficient sunlight to sustain agriculture within a less than transparent historic building. The present invention provides a method outfitting and operating a historic building primarily for cultivation of plants for human consumption near the historic building.

### SUMMARY OF THE INVENTION

Generally, the method for adaptive reuse of historic buildings for high density organic agriculture reutilizes historic properties, many of which are in a high state of distress in urban environments. The method of the present invention creates environmentally controlled plant growing chambers within a retrofitted historic structure. By utilizing historic structures, the present invention reduces logistics costs, negative environmental impacts, and improves the quality of herbs, fruits, vegetables, and other organic products by growing them much closer to the point of consumption than traditional agricultural models while providing year round production capability in property supplied and controlled environments.

The present invention through its interconnected systems facilitates and promotes plant growth in a historic commercial structure and provides a method of growing food, fruit, vegetables, medicinal and non-medicinal organic products in a contained, environmentally controlled environment in historic properties that may otherwise not support adaptive re-use of the structure.

There has thus been outlined, rather broadly, the more important features of the invention in order that the detailed description thereof that follows may be better understood and that the present contribution to the art may be better appreciated. The present invention also includes lighting systems, water delivery systems, plant growing media and potting systems, and computerized controls of the various systems. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with is the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a method for adaptive reuse of historic buildings for high density organic agriculture that provides products to consumers near the historic buildings.

Another object is to provide such a method for adaptive reuse of historic buildings for high density organic agriculture that allows for growing plants in buildings with opaque walls.

Another object is to provide such a method for adaptive reuse of historic buildings for high density organic agriculture that operates upon solar lighting or artificial lighting powered by utility service or renewal energy sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 provides a perspective view of a historic structure utilizing the is present invention;

FIG. 2 shows a sectional view through the historic structure of FIG. 1 with the present invention deployed therein; and,

FIG. 3 shows a flow chart of the method of the invention.

The same reference numerals refer to the same parts throughout the various figures.

### DESCRIPTION OF THE PREFERRED EMBODIMENT

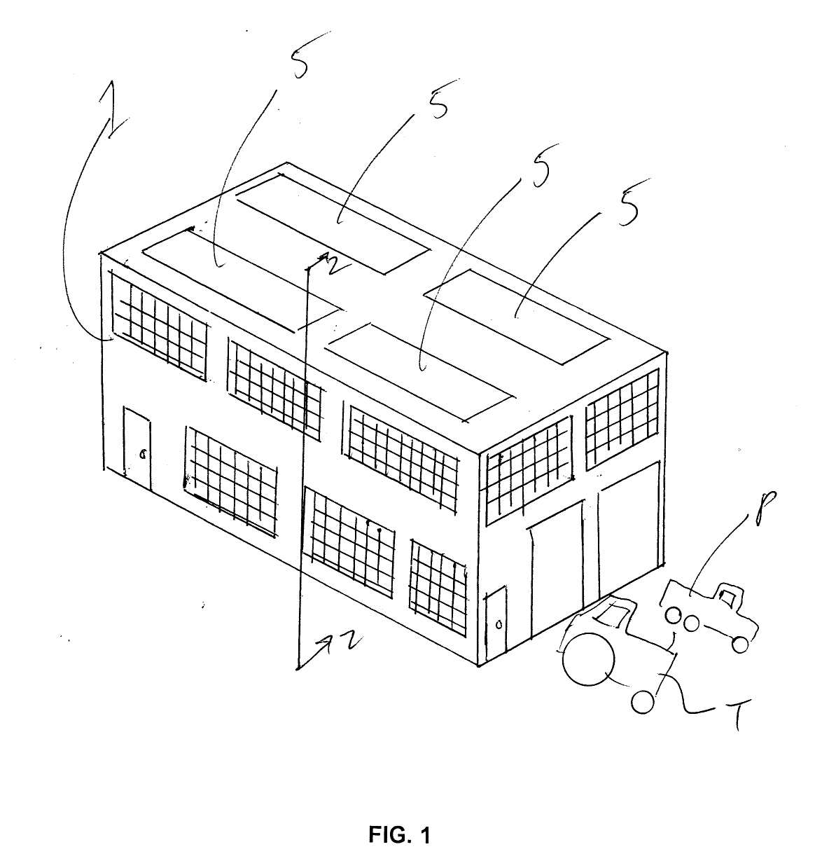

The present art overcomes the prior art limitations by providing a method for adaptive reuse of historic buildings for high density organic agriculture. A historic building may have many forms. FIG. 1, for example, shows a typical historic structure, or building 1, as a two story building with exterior windows and various doors. The building 1 has a flat roof with various solar collectors 5 installed. Though shown in two stories, the Applicant foresees the method of the invention applying to structures of multiple stories. As an agricultural operation with the present invention deployed, the historic structure 1 may have useful vehicles nearby such as a tractor T or a pickup truck P.

The present invention utilizes the following components:

1—A preexisting structure that qualifies for inclusion on the national historic register or for the Federal Historic tax credit that contains functional lighting, heating and cooling systems;

2—LED, Metal Halide, or High Pressure Sodium lighting at sufficient densities and needed wavelengths to promote plant growth;

3—Sterile growing mediums such as perlite or cocoa husk, or in the alternative soilless aeroponic systems that apply nutrients directly to the root systems of the plant to be grown;

4—Reflective films to capture, contain and reflect light, natural or artificial;

5—Solar concentrators, which capture and concentrate natural light into optical plastic tube, may see use depending upon the specific structural configuration of the building 1;

6—A solution of nutrients for application to the plants to promote their growth;

7—A plant potting system that provides for the application of light and nutrients to the plants, and recovers and recycles any excess nutrient solution;

8—A water treatment plant capable of removing excess metals, salts, and other detrimental contaminates to promote plant growth;

9—A metering and application system to regulate the amount of heating, cooling, humidification, ventilation, lighting, and nutrients the plants receive;

10—A humidification/dehumidification system as required to promote plant growth;

11—A ventilation system to remove excess heat or humidity as required to promote plant growth; and,

12—A reservoir, tank or otherwise, for the storage of nutrient solution.

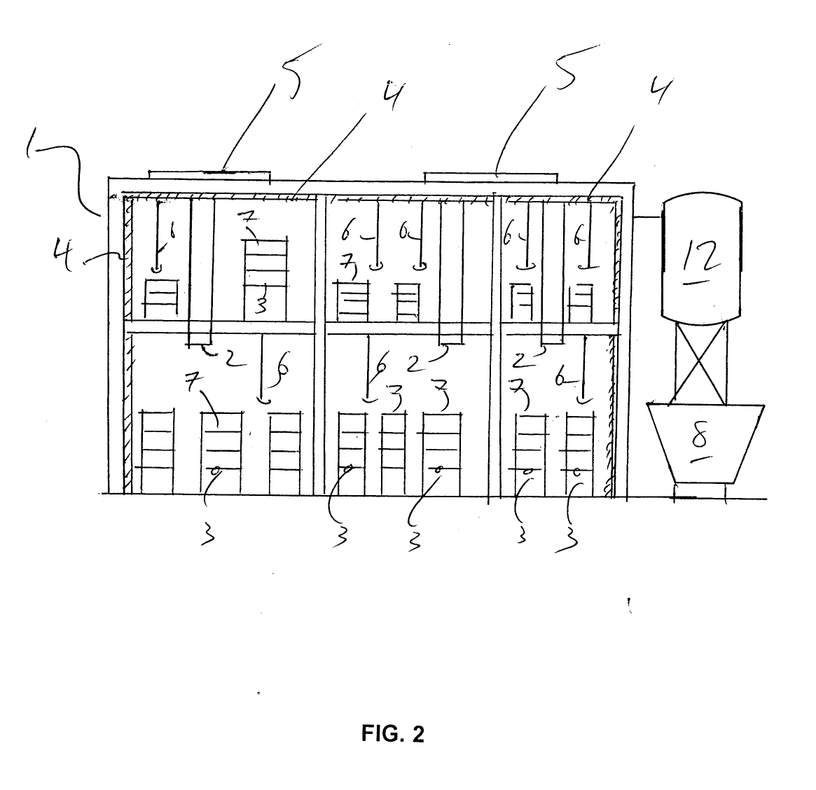

Looking within a historic structure, FIG. 2 shows the present invention deployed upon and within the structure 1. The structure has the water treatment plant 8 upon the exterior but near the building and the reservoir 12 proximate the water treatment plant. To assist in distribution of solution 6 from the reservoir, the reservoir has an elevated location typically to the highest story of the building or alternatively upon the roof. The building, as shown, has two floors and three bays yielding six growing chambers for the length of the building. The interior walls, ceilings, floors, columns, and ridge beams have the reflective film 4 applied. Doing so retains the light supplied to the growing chambers either through artificial lighting 2 or natural lighting through collectors 5. Within a growing chamber, the plants grow within growing media 3 retained in pots generally shown as shelving 7. Proximate each shelving unit, the invention delivers nutrient solution 6 through a spraying mechanism or head. Alternatively, a drip tube provides the nutrient solution 6 directly to the potting system 7.

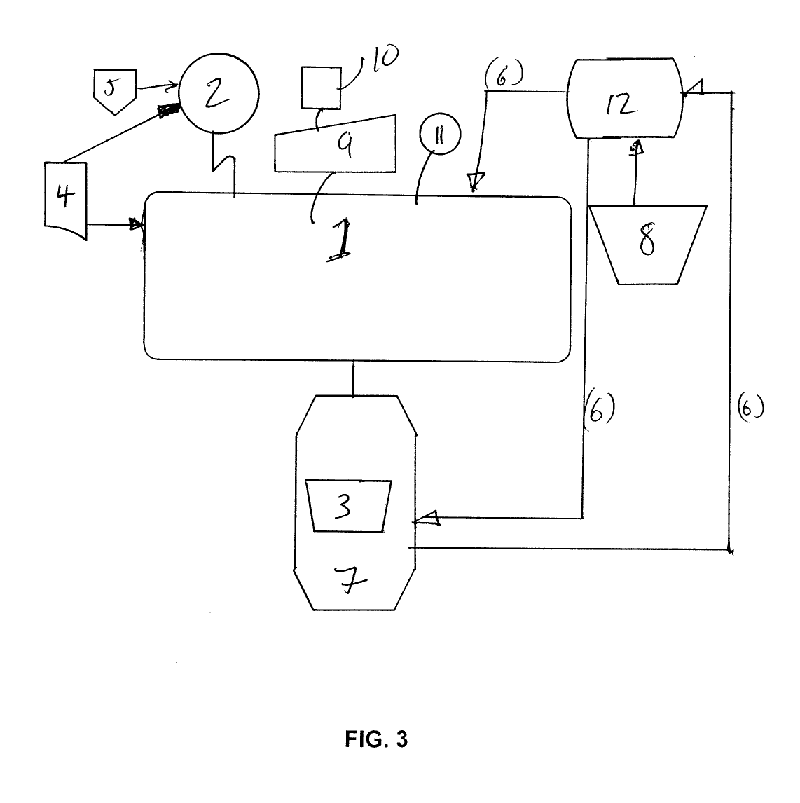

And turning to FIG. 3, this figure shows a flow chart of the systems of the invention in reference to a historic structure 1. The above components, when integrated into cooperation, create an environmentally controlled growing chamber for the growth and production of foods, fruits, vegetables, and the like, as well as other organic medicinal and non-medicinal products. Item 1 provides for the structural shell of the growing chamber, along with basic heating, lighting and cooling capability for the chamber environment. Then item 2 provides the needed spectrum of artificial light in sufficient quantities and at the correct balance of wavelengths to facilitate and promote photosynthesis needed for plant growth within the chamber. Item 3 provides a retention and placement mechanism of the seed or plant to permit delivery of a nutrient solution, as at 6, to the plant roots and to optimally orient the plant for the absorption of natural and/or artificial light. Item 4 is a reflective film attached to the ceiling, walls, floors, columns, and beams of the growing chamber to maximize the amount of available light applied to the plants for their photosynthesis. The film 4 reflects ambient light toward the organic plant material where photosynthesis takes place. Item 5 is a supplemental lighting system that concentrates exterior light rays and delivers them to the growing chamber to reduce the amount of artificial light needed by electrical or petroleum based generation systems. Item 6 is a solution of nutrients suspended in air and/or water that is delivered to the root system for uptake into the plants thereby promoting healthy plant growth. Item 7 is a potting, or containment, system that includes therein a growing medium 3 such as earth or a substitute that contains and recovers excess nutrient solution delivered to the plant roots for recycling. A water treatment plant 8 conditions the is water prior to the addition of specially formulated nutrients and the treatment plant removes excess salts, metals or other contaminates that are toxic or detrimental to healthy plant growth. Item 9 is an electro mechanical metering system for the regulation of heating, cooling, rate of delivery for the nutrient solutions, and management of the artificial lighting system 5 to deliver the correct light spectrums and quantities needed to promote and sustain healthy plant growth. Item 10 is a humidification and dehumidification system to regulate, that is, to add or remove, airborne moisture to provide an optimal respiratory and disease free environment within the growing chamber for healthy plant growth and for the workers tending to the plants. Item 11 is a supplemental fan system to introduce filtered exterior air or to exhaust interior air for maintaining the proper chamber temperature and humidity. Item 12 is a reservoir, of one or more tanks, for the mixing, storage, and recovery of nutrient solution not yet absorbed by the plants growing in the chamber. In an alternate embodiment, the present invention allows for the growth of other organic non-food products such as potted flower or cut flowers.

From the aforementioned description, a method for adaptive reuse of historic buildings for high density organic agriculture has been described. The method for adaptive reuse of historic buildings for high density organic agriculture is uniquely capable of signaling approaching first responders of a user in need who has activated the invention remotely. The method for adaptive reuse of historic buildings for high density organic agriculture and its various components may be manufactured from many materials, including but not limited to, wood, steel, aluminum, polymers, nylon, polyvinyl chloride, high density polyethylene, polypropylene, ferrous and non-ferrous metals, their alloys, and composites.

Various aspects of the illustrative embodiments have been described is using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a is particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A method for adaptive reuse of historic buildings for high density organic agriculture, comprising:
delivering light within at least one historic building;
supplying plants in a growing media within the at least one historic building;
providing an aqueous nutrient solution to the plants;
monitoring the growth of the plants and adjusting the conditions within the at least one historic building;
harvesting the plants; and,
recycling water, nutrient solution, and growing media;
wherein said method products saleable plant based products within at least one historic building.

2. The adaptive reuse method of claim 1 wherein said delivering light includes solar collectors and artificial lighting wherein said delivering light occurs regardless of weather conditions exterior of said at least one historic building.

3. The adaptive reuse method of claim 1 further comprising:
said adjusting the conditions including systems for heating, cooling, humidity, ventilation, and nutrient delivery.
